(19) United States
(12) Patent Application Publication
(10) Pub. No.: US 2019/0064999 A1
(43) Pub. Date: Feb. 28, 2019

(54) MULTI-FREQUENCY SCANNING OF A CAPACITIVE PANEL TO ADDRESS A NOISE CONDITION

(71) Applicant: STMicroelectronics Asia Pacific Pte Ltd, Singapore (SG)

(72) Inventors: Tae-gil Kang, Seoul (KP); Jay Wang, Seoul (KP)

(73) Assignee: STMicroelectronics Asia Pacific Pte Ltd, Singapore (SG)

(21) Appl. No.: 16/058,150

(22) Filed: Aug. 8, 2018

Related U.S. Application Data
(60) Provisional application No. 62/548,659, filed on Aug. 22, 2017.

(51) Int. Cl. G06F 3/041; G06F 3/044

(52) U.S. Cl. CPC G06F 3/0418; G06F 3/044

(57) ABSTRACT

A capacitive panel is scanned with an AC signal having pulses at a first frequency to produce a first frame of mutual capacitance data and pulses at a second frequency, different from the first frequency, to produce a second frame of mutual capacitance data. If neither the first nor second frames of mutual capacitance data is perturbed by noise, then data of the first and second frames of mutual capacitance data is averaged. The averaged data is then used in centroid processing.

### CROSS-REFERENCE TO RELATED APPLICATION

This application claims priority to United States Provisional Application for Patent No. 62/548,659 filed Aug. 22, 2017, the content of which is incorporated by reference.

### TECHNICAL FIELD

The present disclosure generally relates to capacitive sensing panels and, more particularly, to a multi-frequency scanning and mutual capacitance data processing operation in a noise condition.

### BACKGROUND

Touchscreen panels are typically incorporated in various electronic devices to detect a user input (for example, a user touch or hover) and to display content. The touchscreen panels function to both display content through a display panel and detect the user touch/hover through a capacitive sensing panel. The capacitive sensing panel is typically mounted on top of the display panel. The display panel may utilize any of a number of display technologies including LED, LCD, OLED, etc. The capacitive sensing panel includes multiple layers of capacitive sensing circuitry arranged in a pattern. For example, as shown in FIG. 1, a diamond-shaped pattern is one well known sensor pattern wherein rows 10 of interconnected diamond-shaped structures 12 are interleaved with columns 14 of interconnected diamond-shaped structures 16. A small portion of such a capacitive sensing panel with a 3×3 array arrangement is shown in FIG. 1. A first set of lines 20 is connected to the rows and a second set of lines 22 is connected to the columns. The lines 20 and 22 are coupled to a touch screen controller (TSC) circuit 26 that includes both drive circuitry and sense circuitry. The drive circuitry is used to apply an AC transmit signal to individual ones or groups of the lines 20 (referred to as transmit or TX lines) and the sense circuit is used to sense a signal at individual ones or groups of the lines 22 (referred to as receive or RX lines).

The capacitive sensing panel may operate in a number of modes, such as a mutual capacitance sensing mode and a self capacitance sensing mode. Operation in the mutual capacitance sensing mode is further detailed herein. The TSC circuit 26 includes a signal generator (TX) 30 configured to generate the AC transmit signal. An included output multiplexer or row selection circuit (MUX) 32 is controlled to cause the AC transmit signal to be sequentially connected to each TX line 20 and applied to the corresponding row 10. The TSC circuit 26 further includes an analog front end (AFE) circuit 34. An input multiplexer or column selection circuit 36 is controlled to selectively connect the AFE circuit 34 to a subset of the RX lines 22 such that over time all subsets of the RX lines 22 are sequentially connected to the AFE circuit. The AFE circuit 34 includes a plurality of charge to voltage converter (C2V) circuits 38, that plurality being equal in number to the number of RX lines in each subset of RX lines. Each of the C2V circuits 38 is connected by the MUX 36 to an RX line 22 and functions to convert a charge representative of the mutual capacitance at the intersection point between a row 10 and column 12 to a voltage signal. Each voltage signal is then converted to a digital signal by an analog-to-digital converter (ADC) circuit 40 and stored by a control circuit 42 in a memory 44.

In implementations where the total number of C2V circuits 38 is equal to the total number of RX lines 22, the input multiplexing or column selection circuit 38 may be omitted because processing of subsets of the RX lines is not required.

In the self capacitance sensing mode, the TSC circuit 26 would use the input MUX 36 to connect the C2V circuits 38 to both the lines 20 and the lines 22 in order to measure the self capacitance of each row and column. Details of this configuration for operation are not explicitly shown in FIG. 1.

The presence of an object such as a finger or stylus at or near the capacitive sensing panel will cause a change in the mutual capacitance at intersection points between rows 10 and columns 12 that are located near the location of the object. This change in mutual capacitance causes a corresponding change in the voltage signals output by the C2V circuits 38 which are converted to digital signals by the ADC circuit 40. The control circuit 42 may operate to process the stored digital signals to make a determination of the location of the object, with the location data then output by the control circuit 42 to a host through an interface 44. Alternatively, the stored data may be output by the control circuit 42 to the host through the interface 44 for the host to perform the processing operation for determining location of the object.

In the mutual capacitance sensing mode of operation, the TSC circuit 26 operates to sense the mutual capacitance at the intersection point between each row 10 and column 12. One complete scan of the rows and columns produces a corresponding frame of digital mutual capacitance data for storage in the memory 44 which represents the sensed capacitance at each intersection point between a row 10 and column 12. An example of such a frame of digital mutual capacitance data is shown in FIG. 2A (it being understood that only a subset of the digital mutual capacitance data is shown for the intersection points of rows 5-13 and columns 21-30 of the capacitive sensing panel).

The technique for processing the frame of digital mutual capacitance data to determine object location typically uses the steps of: a) filtering the digital mutual capacitance data using a fixed threshold; b) defining a data island which includes only the digital mutual capacitance data which exceeds the fixed threshold; and c) calculating a centroid of the defined data island which provides coordinates of the detected object. This process is generally referred to as centroid processing of the frame of digital mutual capacitance data.

An example of the implementation of the centroid processing process for a collected frame of digital mutual capacitance data is shown in FIGS. 2B-2D. The digital mutual capacitance data is first filtered using a fixed filter threshold. In this case, a filter threshold of 55, for example, is used and all mutual capacitance data in the frame having a value below the threshold is set to 0 as shown in FIG. 2B. The remaining non-zero mutual capacitance data after filtering defines a data island having a boundary 60 as shown in FIG. 2C. Next, the centroid X of the data island is calculated to generate the coordinates of the detected object as shown in FIG. 2D. The coordinates of the centroid X for the object (obj) in this example are P_{obj}=(25.6, 9.13). The mathematical process used for defining the data island and calculating its centroid is well known to those skilled in the art.

Reference is now made to FIG. 3 showing the AC transmit signal that is sequentially applied to the TX lines TX1-TXn. The AC signal is, for example, a square wave signal at a given pulse frequency. Each TX line sequentially receives a burst 70 of pulses 72 of the square wave signal over a burst scan frame 74. The burst scan frame 74 is periodically repeated, with each individual burst scan frame 74 corresponding to one complete scan of the rows and C2V circuit sensing of the columns which produces the frame of digital mutual capacitance data indicative of sensed capacitance at each intersection point.

FIG. 4 is time domain waveform for operation of the TSC circuit 26. The FIG. 4 waveform includes a signal portion 80 which corresponds to a period in time of the burst scan frame 74 during which the AC transmit signal is being sequentially applied to scan the TX lines TX1-TXn. The other portions of the FIG. 4 waveform relate to other operations of the TSC circuit 26 including: performing noise monitoring (region 100) and performing self capacitance sense scanning of the rows and columns (region 102). A corresponding frequency domain plot is shown in FIG. 5 with a frequency portion 82 associated with the AC signal at the given pulse frequency (in this case having a frequency of 280 kHz) for the TX line scan in mutual capacitance sensing. FIG. 5 further shows a frequency portion 104 associated with the self capacitance sensing operation and harmonic signals 106.

It is known in the art that external noise is concern with respect to the operation of the capacitive sensing panel. Sources of such external noise include DC-DC power converter circuits used to supply operating power to the system. FIG. 6 shows a frequency domain plot of an example noise signal 86. The bandwidth of that noise signal 86 is quite wide, for example in the range of 60 kHz. Such a bandwidth can easily cover the AC transmit signal at one or more given pulse frequencies and indeed may be wider than a range of frequencies over which the pulse frequency of the AC transmit signal hops during frequency hopping implementations. Furthermore, the noise signal and its harmonic(s) may shift in frequency over time to cover the AC signal. FIG. 6 illustrates a scenario where the frequency of the noise signal generally coincides with the pulse frequency of the AC transmit signal (at around, for example, a frequency of 280 kHz). In such a case, the data in the frame of digital mutual capacitance data will be perturbed by the noise.

Reference is now made to FIG. 7. A typical operation of the TSC circuit 26 is to perform 90 the complete scan of the rows and sensing of the columns and produce the frame of digital mutual capacitance data during one period of time 92 and process 94 the frame of digital mutual capacitance data to determine and output object location during a next immediately succeeding period of time 96. The period of time 92 may generally speaking correspond to the burst scan frame 74 of FIG. 3. Because the scanning operation occurs primarily using analog domain circuitry and the frame processing operation occurs primarily using digital domain circuitry, the TSC 26 may be configured in a manner where a next complete scan of the rows and sensing of the columns to produce the next frame of digital mutual capacitance data (reference 90) is performed by the analog domain circuit during the period of time 96 where the digital domain circuitry is processing the preceding frame of digital mutual capacitance data.

There is a need in the art for an improved panel scan and frame processing operation to address noise conditions.

### SUMMARY

In an embodiment, a method comprises: scanning a capacitive panel with an AC signal having pulses at a first frequency to produce a first frame of capacitance data; scanning the capacitive panel with the AC signal having pulses at a second frequency, different from the first frequency, to produce a second frame of capacitance data; discarding the first frame of capacitance data if data therein is perturbed by noise; discarding the second frame of capacitance data if data therein is perturbed by noise; accumulating data from the first and second frames of capacitance data if data in neither the first nor second frames of capacitance data is perturbed by noise; and performing centroid processing on the accumulated data.

In an embodiment, a method comprises: scanning a capacitive panel with an AC signal having pulses at a first frequency to produce a first frame of mutual capacitance data; scanning the capacitive panel with the AC signal having pulses at a second frequency, different from the first frequency, to produce a second frame of mutual capacitance data; determining whether data of the first and second frames of mutual capacitance data is perturbed by noise; and performing centroid processing on data of the first and second frames of mutual capacitance data that is not perturbed by noise. The step of performing includes: accumulating data from the first and second frames of mutual capacitance data if data in neither the first nor second frames of mutual capacitance data is perturbed by noise; and using the accumulated data for centroid processing.

The foregoing and other features and advantages of the present disclosure will become further apparent from the following detailed description of the embodiments, read in conjunction with the accompanying drawings. The detailed description and drawings are merely illustrative of the disclosure, rather than limiting the scope of the invention as defined by the appended claims and equivalents thereof.

### BRIEF DESCRIPTION OF DRAWINGS

Embodiments are illustrated by way of example in the accompanying figures not necessarily drawn to scale, in which like numbers indicate similar parts, and in which:

FIG. 1 shows a capacitive sensing panel and control circuit in a prior art configuration;

FIGS. 2A-2D show the process implemented by the control circuit in FIG. 1 for touch coordinate determination;

FIG. 3 shows an AC transmit signal that is sequentially applied to transmit lines;

FIG. 4 is time domain waveform for operation of the control circuit;

FIG. 5 is a frequency domain plot of the operational waveform;

FIG. 6 is a frequency domain plot of a noise signal;

FIG. 7 is timing diagram showing operation of the control circuit for panel scan and frame processing;

FIG. 8 shows an AC transmit signal that is sequentially applied to transmit lines;

FIG. 9 is time domain waveform for operation of the control circuit

FIG. 10 is a frequency domain plot of the operational waveform;

FIG. 11 is timing diagram showing operation of the control circuit for panel scan and frame processing; and

FIG. 12 is flow diagram showing the frame processing operation.

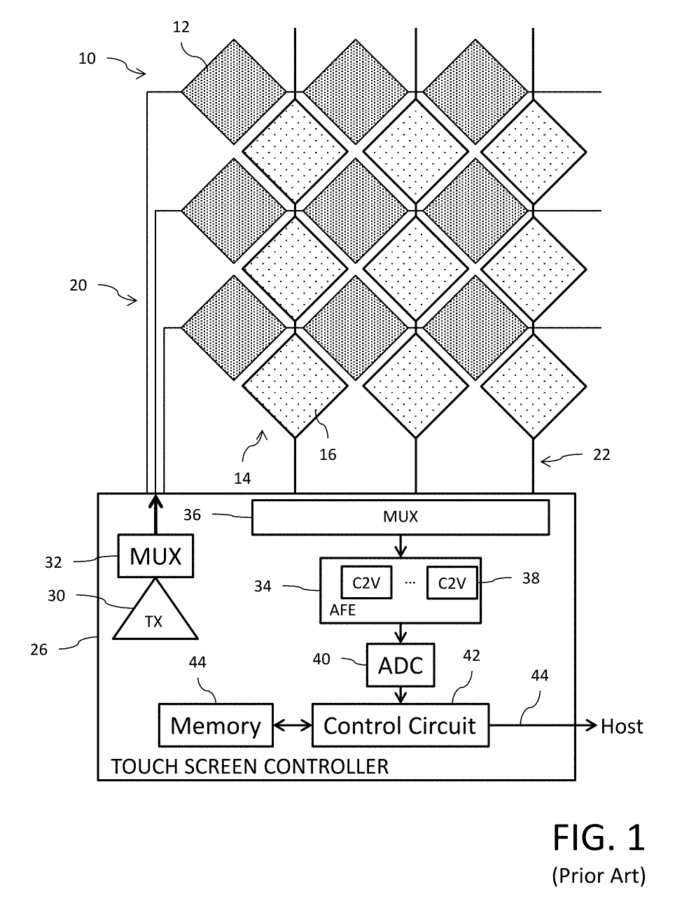

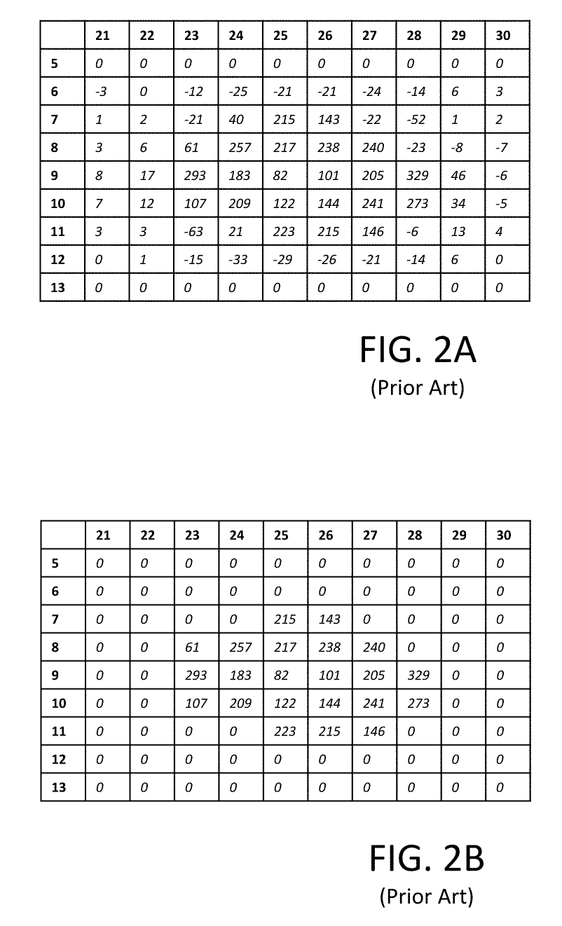

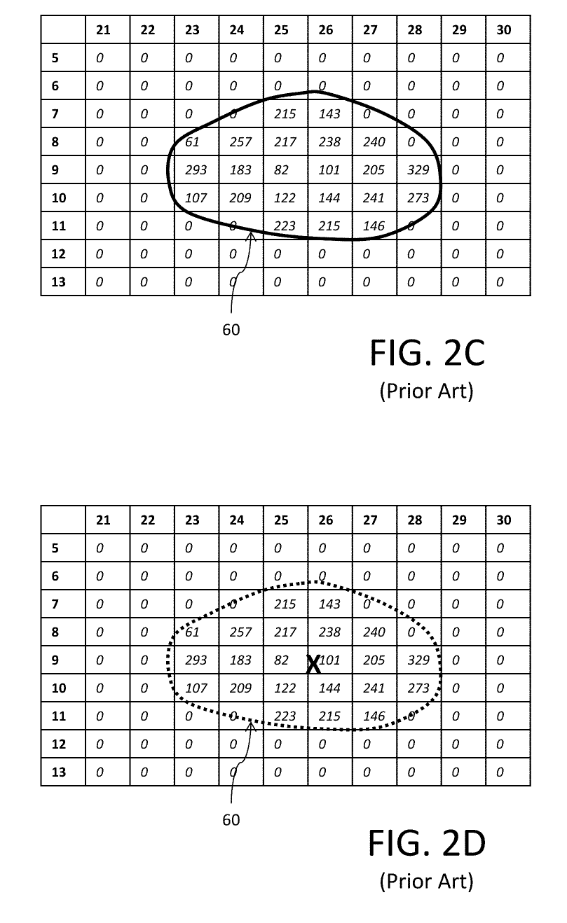

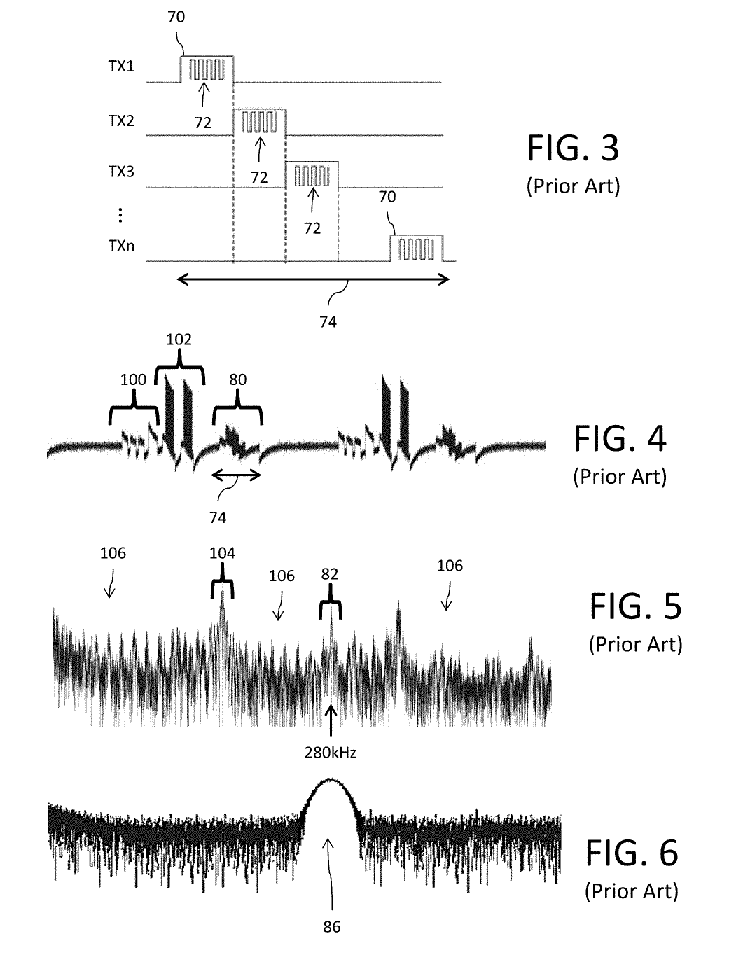

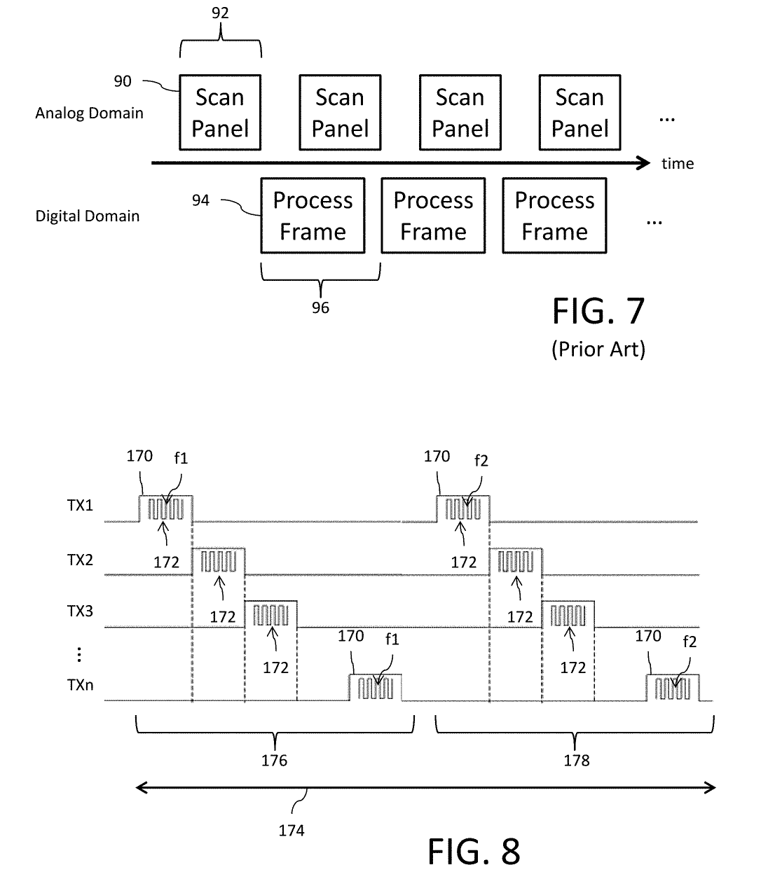

### DETAILED DESCRIPTION

Reference is now made to FIG. 8 showing the AC transmit signal that is sequentially applied to the TX lines TX1-TXn by the TSC 26 in an embodiment to address noise conditions. The AC signal is a square wave signal that is generated at a two distinct pulse frequencies. Each burst scan frame 174 includes a first scan portion 176 where the AC signal has a first pulse frequency f1 and a second scan portion 178 where the AC signal has a second pulse frequency. During the first scan portion, each TX line sequentially receives a burst 170 of pulses 172 of the square wave signal at the first frequency f1. During the second scan portion, each TX line sequentially receives a burst 170 of pulses 172 of the square wave signal at the second frequency f2. The burst scan frame 174 is periodically repeated. Each individual scan portion 176, 178 of the burst scan frame 174 corresponds to one complete scan of the rows and C2V sensing of the columns which produces a corresponding frame of digital mutual capacitance data.

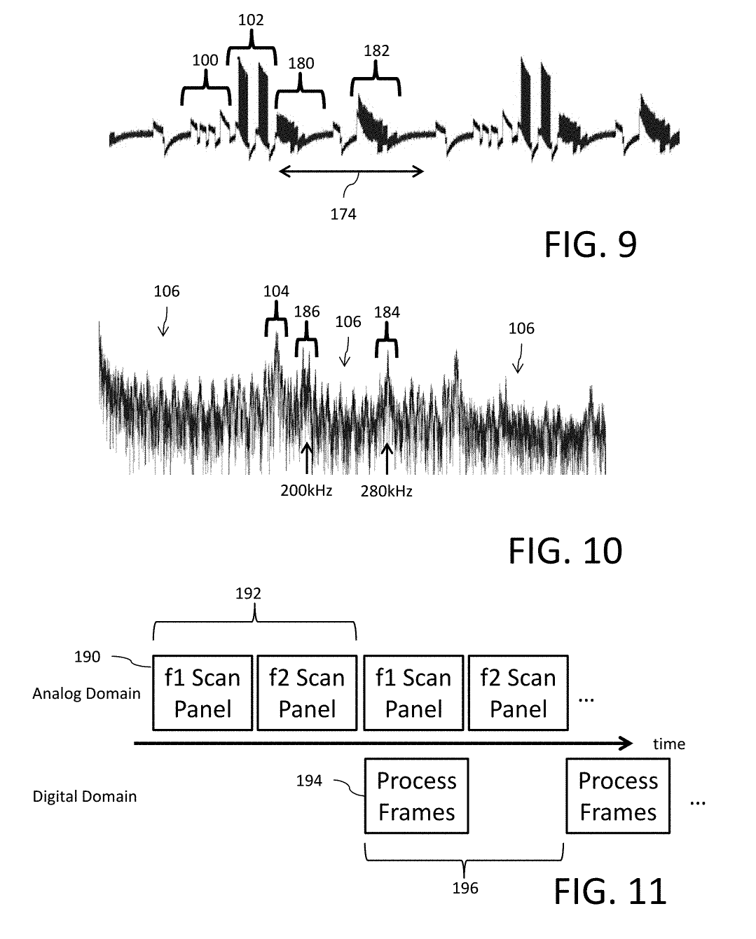

FIG. 9 is time domain waveform for operation of the TSC circuit 26 in the embodiment to address noise conditions. The FIG. 9 waveform includes a signal portion 180 which corresponds to a period in time of the burst scan frame 174 during which the AC transmit signal is being sequentially applied to the TX lines TX1-TXn with the first pulse frequency. FIG. 9 further includes a signal portion 182 which corresponds to a period in time of the burst scan frame 174 during which the AC transmit signal is being sequentially applied to the TX lines TX1-TXn with the second pulse frequency. A corresponding frequency domain plot is shown in FIG. 10 with a frequency portion 184 associated with the AC signal at the first pulse frequency (in this case having a frequency of 280 kHz) and a frequency portion 186 associated with the AC signal at the second pulse frequency (in this case having a frequency of 200 kHz).

In the embodiment to address noise conditions, the TSC circuit 26 operates as shown in FIG. 11 to perform 190 two distinct and complete scans of the rows and sensing of the columns and produce two distinct corresponding frames of digital mutual capacitance data during one period of time 192 and process 194 the frames of digital mutual capacitance data to determine and output object location during a next immediately succeeding period of time 196. As noted in connection with FIG. 8, the performance 190 of two distinct and complete scans involves a first scan portion 176 where the AC signal has a first pulse frequency f1 and a second scan portion 178 where the AC signal has a second pulse frequency f2. The period of time 192 generally corresponds to the burst scan frame 174. Because the scanning operation occurs primarily using analog domain circuitry and the frame processing operation occurs primarily using digital domain circuitry, the TSC 26 may be configured in a manner where a next operation to perform two distinct and complete scans of the rows and sensing of the columns to produce the next two distinct corresponding frames of digital mutual capacitance data is performed by the analog domain circuit during the period of time 196 where the digital domain circuitry is processing the preceding two frames of digital mutual capacitance data.

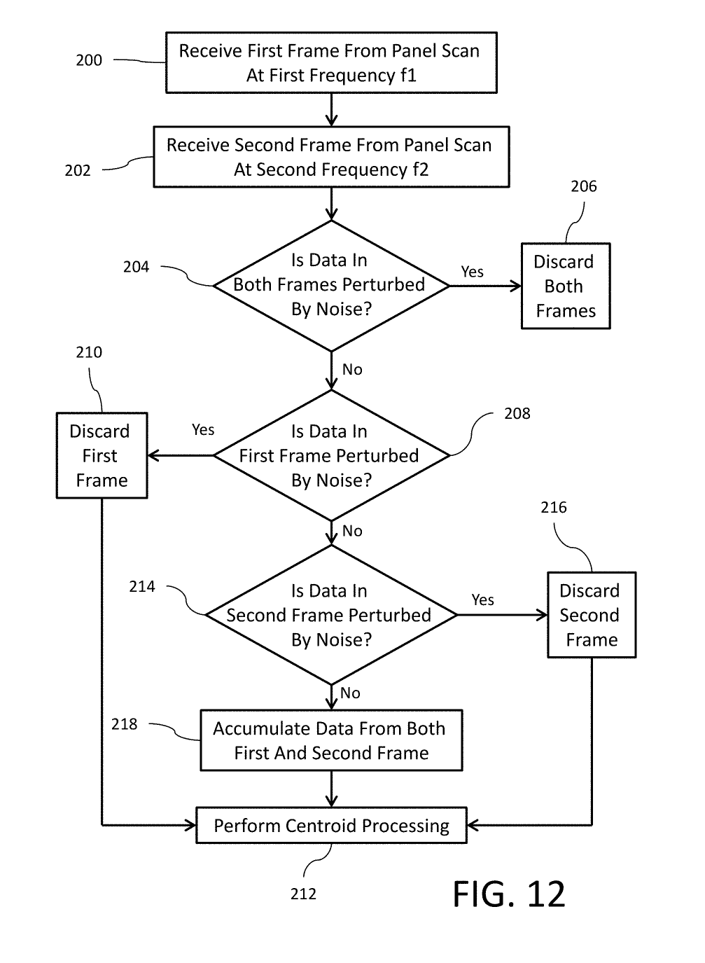

FIG. 12 is flow diagram showing the frame processing operation. The first frame of digital mutual capacitance data from the complete scan of the rows and sensing of columns with the AC signal at the first pulse frequency f1 is received in step 200. The second frame of digital mutual capacitance data from the complete scan of the rows and sensing of the columns with the AC signal at the second pulse frequency f2 is received in step 202. In step 204, a determination is made as to whether the data in both frames is perturbed by noise. If yes, then in step 206, both frames are discarded and the process returns. If no, a determination is made in step 208 as to whether the data in the first frame is perturbed by noise. If yes, then in step 210 the first frame is discarded and centroid processing in step 212 is performed using only the second frame of data. If no, then in step 214 a determination is made as to whether the data in the second frame is perturbed by noise. If yes, then in step 216 the second frame is discarded and centroid processing in step 212 is performed using only the first frame of data. If no, then in step 218 the data from the first and second frames is accumulated and centroid processing in step 212 is performed using the accumulated data from both the first and second frames. In an embodiment, the accumulation that is performed may implement an averaging of the data in the first and second frames, with the averaged data used for centroid processing.

The foregoing description has provided by way of exemplary and non-limiting examples a full and informative description of one or more exemplary embodiments of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

What is claimed is:

1. A method, comprising:
scanning a capacitive panel with an AC signal having pulses at a first frequency to produce a first frame of capacitance data;
scanning the capacitive panel with the AC signal having pulses at a second frequency, different from the first frequency, to produce a second frame of capacitance data;
discarding the first frame of capacitance data if data therein is perturbed by noise;
discarding the second frame of capacitance data if data therein is perturbed by noise;
accumulating data from the first and second frames of capacitance data if data in neither the first nor second frames of capacitance data is perturbed by noise; and
performing centroid processing on the accumulated data.

2. The method of claim 1, further comprising performing centroid processing on the data of the first frame of capacitance data when the data in the second frame of capacitance data is perturbed by noise.

3. The method of claim 1, further comprising performing centroid processing on the data of the second frame of capacitance data when the data in the first frame of capacitance data is perturbed by noise.

4. The method of claim 1, wherein accumulating comprises averaging the data in the first and second frames of capacitance data.

5. The method of claim 1, wherein the capacitance data is mutual capacitance data.

6. A circuit for controlling operation of a capacitive sensing panel including a plurality of drive lines and a plurality of sense lines, comprising:
a transmit circuit configured to generate an AC signal having pulses for application to the plurality of drive lines;
a conversion circuit configured to sense charge at the plurality of sense lines and generate a frame of capacitance data;
wherein the transmit circuit is controlled to apply pulses of the AC signal at a first frequency and the conversion circuit operates to produce a first frame of capacitance data;
wherein the transmit circuit is further controlled to apply pulses of the AC signal at a second frequency, different from the first frequency, and the conversion circuit operates to produce a second frame of capacitance data; and
a processing circuit configured to:
discard the first frame of capacitance data if data therein is perturbed by noise;
discard the second frame of capacitance data if data therein is perturbed by noise;
accumulate data from the first and second frames of capacitance data if data in neither the first nor second frames of capacitance data is perturbed by noise; and
perform centroid processing on the accumulated data

7. The circuit of claim 6, wherein the processing circuit is further configured to perform centroid processing on the data of the first frame of capacitance data when the data in the second frame of capacitance data is perturbed by noise.

8. The circuit of claim 6, wherein the processing circuit is further configured to perform centroid processing on the data of the second frame of capacitance data when the data in the first frame of capacitance data is perturbed by noise.

9. The circuit of claim 6, wherein accumulating comprises averaging the data in the first and second frames of capacitance data.

10. The circuit of claim 6, wherein the capacitance data is mutual capacitance data.

11. A method, comprising:
scanning a capacitive panel with an AC signal having pulses at a first frequency to produce a first frame of mutual capacitance data;
scanning the capacitive panel with the AC signal having pulses at a second frequency, different from the first frequency, to produce a second frame of mutual capacitance data;
determining whether data of the first and second frames of mutual capacitance data is perturbed by noise; and
performing centroid processing on data of the first and second frames of mutual capacitance data that is not perturbed by noise.

12. The method of claim 11, wherein performing includes:
accumulating data from the first and second frames of mutual capacitance data if data in neither the first nor second frames of mutual capacitance data is perturbed by noise; and
using the accumulated data for centroid processing.

13. The method of claim 12, wherein accumulating comprises averaging the data in the first and second frames of mutual capacitance data.

14. The method of claim 11, wherein determining further comprises discarding the first frame of mutual capacitance data if data therein is perturbed by noise.

15. The method of claim 11, wherein determining further comprises discarding the second frame of mutual capacitance data if data therein is perturbed by noise.

16. A circuit for controlling operation of a capacitive sensing panel including a plurality of drive lines and a plurality of sense lines, comprising:
a transmit circuit configured to generate an AC signal having pulses for application to the plurality of drive lines;
a conversion circuit configured to sense charge at the plurality of sense lines and generate a frame of capacitance data;
wherein the transmit circuit is controlled to apply pulses of the AC signal at a first frequency and the conversion circuit operates to produce a first frame of capacitance data;
wherein the transmit circuit is further controlled to apply pulses of the AC signal at a second frequency, different from the first frequency, and the conversion circuit operates to produce a second frame of capacitance data; and
a processing circuit configured to:
determine whether data of the first and second frames of mutual capacitance data is perturbed by noise; and
perform centroid processing on data of the first and second frames of mutual capacitance data that is not perturbed by noise

17. The circuit of claim 16, wherein the processing circuit is further configured to:
accumulate data from the first and second frames of mutual capacitance data if data in neither the first nor second frames of mutual capacitance data is perturbed by noise; and
use the accumulated data for centroid processing.

18. The circuit of claim 17, wherein accumulating comprises averaging the data in the first and second frames of mutual capacitance data.

19. The circuit of claim 16, wherein the processing circuit is further configured to discard the first frame of mutual capacitance data if data therein is perturbed by noise.

20. The circuit of claim 16, wherein the processing circuit is further configured to discard the second frame of mutual capacitance data if data therein is perturbed by noise.
